(19) United States
(12) Patent Application Publication
(10) Pub. No.: US 2003/0225761 A1
(43) Pub. Date: Dec. 4, 2003

(54) System for managing and searching links

(75) Inventors: Ryan John Wagener, Arlington, VA (US); Douglas Carter Mitchell, Herndon, VA (US)

Correspondence Address: STAAS & HALSEY LLP, SUITE 700, 1201 NEW YORK AVENUE, N.W., WASHINGTON, DC, 20005, US

(73) Assignee: American Management Systems, Inc., Fairfax, VA (US)

(21) Appl. No.: 10/448,119

(22) Filed: May 30, 2003

Related U.S. Application Data
(60) Provisional application No. 60/384,087, filed on May 31, 2002.

(51) Int. Cl. G06F 17/30

(52) U.S. Cl. 707/6

(57) ABSTRACT

A system for link analysis, having records of plural record types, and having links of plural link types, the links linking pairs of the records. Some of the pairs may be of different record types. The system may also have an index indexing the records of plural record types. The record types may have respectively different sets of fields. The index may index one or more of the fields of each of the records. The records may correspond to real world entities or information, and the fields and their names may correspond to attributes of the entities. Metadata or the like may map the fields to the field names, and may be used to sensibly display related information, such set of the records, etc. All entities or records may be searched, which may be combined with link search and analysis. Point-to-point searches and repeated search refinement may also be provided.

### CROSS-REFERENCE TO RELATED APPLICATION

This application is related to and claims priority to U.S. provisional application entitled “Link Analysis System” having serial No. 60/384,087, by Ryan John Wagener, filed May 31, 2002, and incorporated by reference herein.

### BACKGROUND OF THE INVENTION

1. Field of the Invention

The present invention is directed to a system and method for supporting and performing link analysis. Link analysis may be defined to be the study of direct and indirect relationships between entities or individuals. More specifically, the present invention relates to a system for flexibly organizing, storing, and searching links and different types of entities or records that may be directly or indirectly linked or associated with one another.

2. Description of the Related Art

Initially, the field of link analysis involved manual processes of identifying relationships between entities such as people, organizations, and assets, both tangible and intangible. For example, if a counter-terrorism investigator investigating a terrorist network were seeking to determine the extent of the network—for example whether and how two different individuals are directly or indirectly connected with each other—the investigator would review various sources such as documents, databases, people, etc. and try to identify relevant data. The investigator would attempt to synthesize many separate pieces of information, often from various sources, and try to determine how, if at all, the information was inter-related. To help with the analysis, the investigator sometimes, if possible, would manually diagram information related to the subject of interest. Lines or links would be drawn between the subject's nodes to reflect possible connections between the entities or subjects.

FIG. 1 shows an example of a link diagram 10 that might be manually drawn. The investigator, with or without a diagram may be able to follow links 11 to determine a previously unknown indirect relationship between person Pat 12 and person Tracy 14. An indirect path may be defined as a path having at least two links that contribute to indirectly connecting two entities at the ends of the path. However, an individual has a limited ability to identify or map multiple levels of indirect links between or among entities, so resulting analysis was often limited in depth or scope. Further, it was very difficult to work with large data sets and refine them down to meaningful, useable search results.

Various tools for analyzing a known set of links have been developed. However, these tools have been generally limited to visualizing previously identified connections and other simple operations. Furthermore, links have been between monolithic data. For example, links would be used to relate a limited rigid set of data of a single data type. There might be a table for records of people, a different table for records of telephones, and a different table for records of organizations. Links would be scoped in relation only to a particular table or format. For example, the persons Pat 12 and Tracy 14 would be stored in the one table or dataset with one format, organizations such as corporations and banks would be stored in another table or dataset with another format. Searches on the data were cumbersome and inflexible. Searches encompassing all of the tables or different record types could not be performed in a single search, but rather each table or subject type had to be searched separately and manually. It was also not possible to initially search multiple entities of multiple entity types and use the results as a direct source or basis for a more carefully defined link search or link analysis.

An investigator researching an individual suspected of being involved in a terrorist network may have only a name to begin his or her search and analysis. The investigator would want to search a variety of sources for more information about the individual—those sources would generally have different formats and content and would be prepared by different researchers, law enforcement organizations, governments, newspapers, etc. The individual in question may be referred to in several different ways. For example, suspected terrorist John Smith may be referred to as “J Smith”, “the John Smith terrorist cell”, etc. In prior art link analysis systems, the investigator would have to perform multiple searches to find relevant information about John Smith, such as searching one source for people known as “John Smith,” searching another source for companies called “John Smith,” searching another source or dataset for organizations known as “John Smith,” searching another source for bank accounts owned by “John Smith,” or searching yet another source for telephone numbers assigned to “John Smith”, to name only a few possibilities. The investigator would then have to construct the links, if any, among the resulting data.

What is needed is a system to provide comprehensive and convenient searching and link analysis. An investigator needs to be able to perform a single search that will effectively show all data known about a subject or entity, regardless of whether that data relates to a person, company, organization, bank account, telephone or any other type of entity. An investigator needs to be able to identify all of the links among such resulting data. What is also needed is a system providing flexible storage, searching, and analysis of data related to multiple entity types including links.

### SUMMARY OF THE INVENTION

It is an aspect of the present invention to provide a system for flexibly and efficiently searching a set of differing types of entities or records and links thereto.

It is another aspect of the present invention to provide a system for using metadata or a metatable to allow a generic record type to be used.

It is a further aspect of the present invention to provide a system for allowing a single search of many entity or record types and then allowing a link search limited in scope to links connected to records or entities of the result of the single search.

It is still another aspect of the present invention to provide a system for link search and analysis where the records and links thereto are associated with documents from which the data has been retrieved.

It is another aspect of the present invention to provide a system for link analysis where indirect relationships between two entities, of possibly different types, may be searched for, and where the relationships may be chains of links and entities of any different types connecting the two entities.

It is yet another aspect of the present invention to provide a system for link analysis where records are obtained from documents that are then stored in association with the records, and where links are also stored in association with the document and records.

It is a further aspect of the present invention to provide a system for link analysis where a database of entity records and links between them stores entity records of different types and links of possibly different types may link any of the entity records without regard for the type of such entity records.

It is still another aspect of the present invention to provide a system for link analysis where a search result may be initially obtained with one of a variety of search types (e.g. a search for entities), and the search result may be repeatedly refined by further application of the search types.

Another aspect of the present invention is to provide a system where direct and indirect paths between entities can be found without regard for what types of links or entities form such paths.

The above aspects can be attained by a system having plural records of plural different record types stored in a data storage unit, and having plural links of plural link types stored in the data storage unit and linking pairs of the records, where at least some of the pairs are records of different record types. The system may also have an index indexing the plural records of plural different record types. The plural record types may have names of fields and the plural record types vary in a number of field names or names of fields. The plural records may also have fields corresponding to the field names of their respective record types, where the records are stored with a same record storage format, and where the different record types vary in number of fields or names of fields. The index may index one or more of the fields of each of the plural records of plural different record types. The records may correspond to real world entities or information, and the fields and their names may correspond to attributes of the entities. Metadata or the like may be used to map the fields to the field names, and may be used to sensibly display related information, such as a set of the records, etc. The records and links may represent real world information manually or automatically derived from documents or the like. All of the entity records may be quickly searched at one time. Point-to-point searches for paths between entities may be performed without regard for link or entity types in such paths. Search results may be iteratively refined.

These together with other aspects and advantages which will be subsequently apparent, reside in the details of construction and operation as more fully hereinafter described and claimed, reference being had to the accompanying drawings forming a part hereof, wherein like numerals refer to like parts throughout.

### BRIEF DESCRIPTION OF THE DRAWINGS

FIG. 1 shows an example of a link diagram 10.

FIG. 2 shows a workflow process.

FIG. 3 shows a possible hardware arrangement.

FIG. 4 shows a conceptual diagram of structuring of data in the data repository or database 38.

FIG. 5 shows examples of possible tables or datasets.

FIG. 6 shows a possible process for entering data from a document.

FIG. 7 shows a view 130 of a queue of documents nominated for data entry.

FIG. 8 shows a typical data entry screen 140.

FIG. 9 shows an exemplary company entity type tab view 150 and a location entity type tab view 152.

FIG. 10 shows a vehicle entity type tab view 162 for entering vehicle entity type records and a link entry tab 164 for displaying links related to the current document and which displays links created using the Create Links interface 166.

FIGS. 11A and 11B show examples of possible entity categories and link types.

FIG. 12 shows a process for performing an all-entities search.

FIG. 13 shows a process flow for performing refined searches.

FIG. 14 shows a practical consequence of the search refinement capability discussed with reference to FIG. 13.

FIG. 15 shows a simple entity search screen that might implement an all-entities search 206.

FIG. 16 shows an example of a search result 256 from an all-entities or restricted all-entities search.

FIG. 17 shows an interface or input area 260 that could be used to implement the links search 208.

FIG. 18 shows a typical links search result 270 from a links search 208.

FIG. 19 shows an example document search interface 280 and an example of document search results 282.

FIG. 20 shows an example document view 290.

FIG. 21 shows other document-related information such as entities in the document that lack links or attributes 300 and detailed document information 302.

FIG. 22 shows a general process flow for performing a point-to-point search 204.

FIG. 23 shows a typical interface 322 for selecting 310, 312 starting and ending subject/criteria, and a typical interface 334 for displaying 318, 320 and selecting 322, 324 starting and ending entities to find point-to-point paths between.

FIG. 24 shows an algorithm that may be used to search for paths between two points or entities.

FIG. 25 shows a typical interface 354 for displaying 330 found path information.

FIG. 26 shows a typical visualization that might be obtained using a commercially available visualization tool.

FIG. 27 shows an interface 370 for imposing link rules.

### DETAILED DESCRIPTION OF THE PREFERRED EMBODIMENTS

Data Entry and Workflow

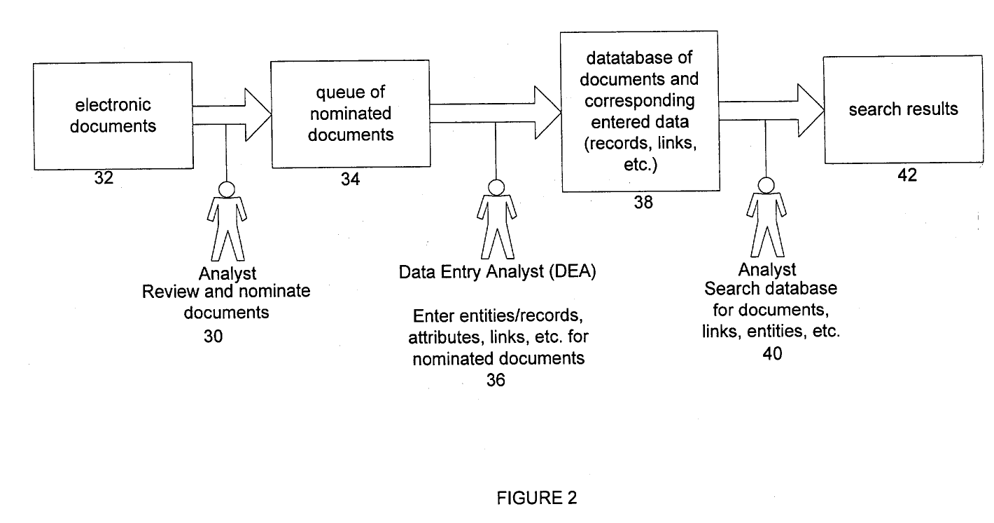

FIG. 2 shows a workflow process. Because link analysis generally is used for analyzing links between real world entities, a process for obtaining and using real world information corresponding to the links and entities is called for. In one embodiment, it is possible for the entity information to be derived from electronic documents or communications 32. Where large volumes of documents 32 are of interest, such as electronic mail, messages, or other documents, including documents used by the intelligence-gathering community, etc., an Analyst 30 may review and nominate documents 32 for data entry. Such nominated documents may go in a temporary queue 34, where they are kept until completion of data entry analysis upon them. Generally, a Data Entry Analyst (DEA) 36 will pull a document from the queue 34, view the document, extract information of items or entities, attributes thereof, and links between entities or items, and enter the information as records into a database or data repository 38. When data entry for a document is complete, it is removed from the queue 34, and stored in the database 38 in association with the link and entity information extracted from the document by the DEA 36. As documents and related information are stored in the database 38, they become available for search and analysis by an Analyst 40, who may search for entities, links, paths between entities, etc. Search results 42 therefrom may be visualized and manipulated with off the shelf visualization tools, if desired. In FIG. 2, Analyst 30, DEA 36, and Analyst 40 are presented as separate individuals. However, it is possible that one person or several people can perform these functions.

Although the document-based aspect can be useful in some applications, it is not a necessary aspect of the invention. Following is a detailed description of the arrangement and structure of data storage and the processes of using such data.

Hardware Setting

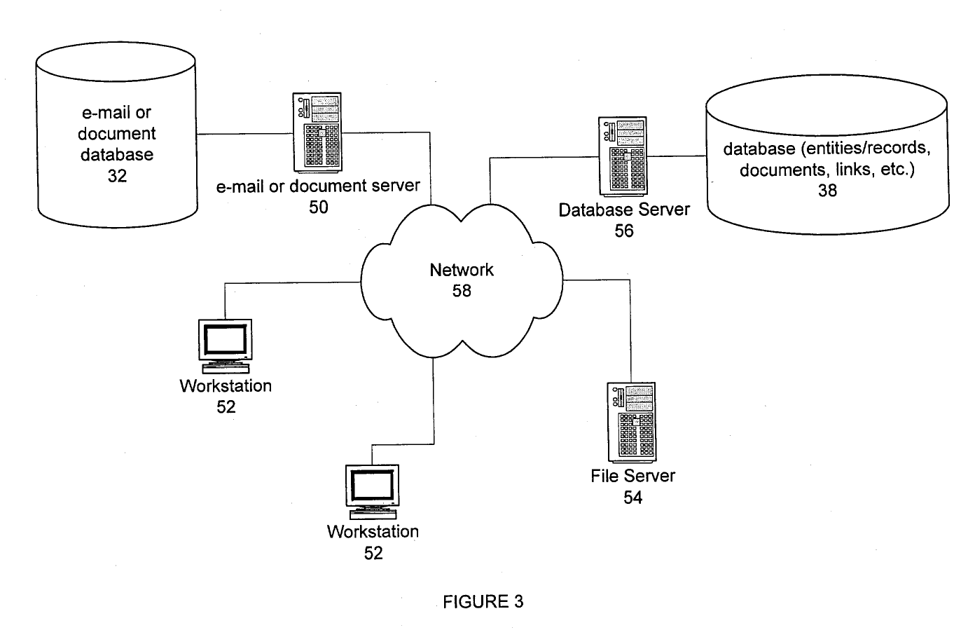

FIG. 3 shows a possible hardware arrangement. The documents may originate from a document database 32, which may in turn be part of or managed by an e-mail or document server 50. The various Analysts 30, 36, 40 may use client workstations 52. A file server 54 may be useful for hosting the queue 34, or for storing documents having been subjected to data entry, in which case references to the documents (rather than the documents themselves) may be stored in the database 38. A database server 56 may provide access to the database 38. A network 58 may be used to enable interoperation between the various components mentioned above. Other architectures and arrangements may also suffice. For example, all functionality could be provided on one system. The database 38 could be distributed across multiple servers. When sensitive information is involved, a secure or isolated network may be called for.

Structure of Stored Data

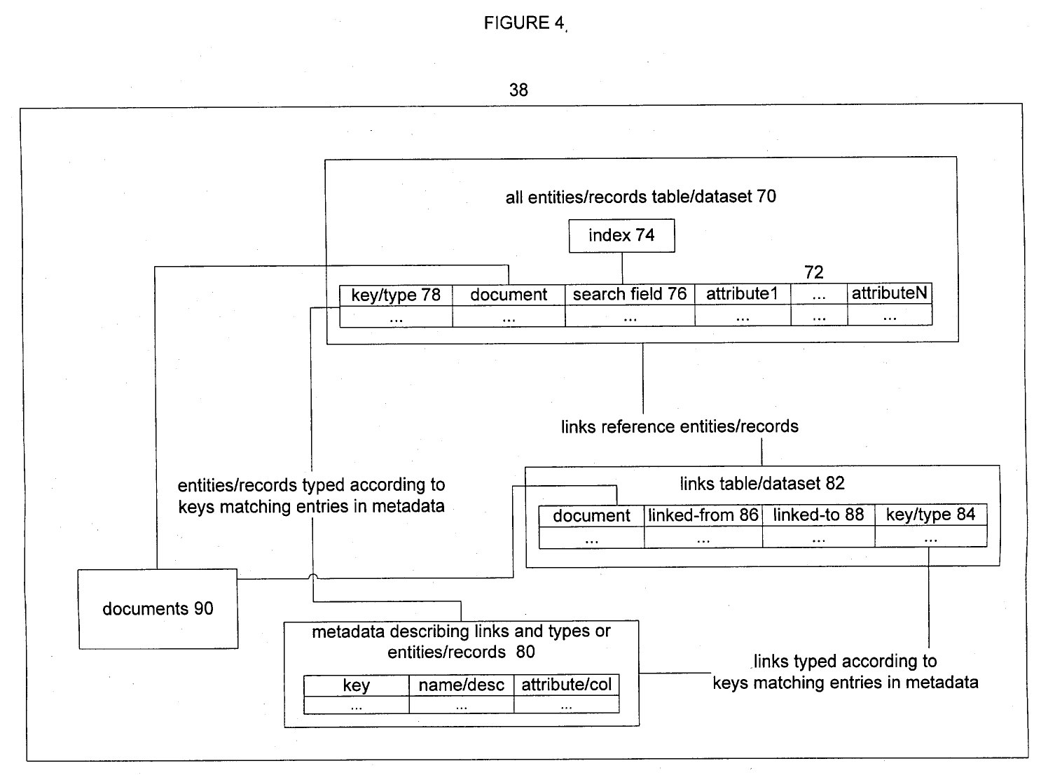

FIG. 4 shows a conceptual diagram of structuring of data in the data repository or database 38. Data structures without a stand-alone database would have a similar arrangement. As discussed in the Background, a problem with prior link analysis systems has been the inability to search, at one time, many different types of entities with pre-established links therebetween. The present invention uses a flexible data-structuring scheme, where different types of entities (or records thereof) are stored in a single dataset or single data format. In FIG. 4, that dataset is shown as the all-entities/records table/dataset 70.

The all-entities table 70 will generally comprise a table or dataset of records with a generic layout or format (for storage) as shown by table structure 72, and will have an index 74 indexing a search field 76. The search field 76 may comprise copies or references to various of the attributes 1 to N, preferably according to record type. Because the records in the table/structure 70/72 are generic, the key/type 78 identifies the type of any given entity record in the all-entities table/dataset 70. The meaning of data in any given attribute column for any given record will depend on its type key 78, and such meaning will be described or named by metadata table 80. In the metadata table 80, there may be multiple entries for any given type or key. That is to say, each entity type described in the metadata table 80 may have a number of different named attributes. The named attributes and other information unique to an entity type are preferably stored as metadata. The metadata is information that maps the generic format (e.g. columns of table 70) of the entity records to corresponding identification, typings, descriptions, etc. In other words, the metatable or metadata acts as a mask to more sensibly present the generically stored data. Typically, the key field 78 included with each entity record will identify the type of the entity record and will be used to find the metadata describing or corresponding to a given entity record.

Similarly, the links table/dataset 82 will be typed by a type key 84 keyed to the metadata table 80. The links table 82 will also include fields linked-from 86 and linked-to 88, which identify the two entities in all-entities table 70 that are linked by any given link record in the link table 82. The linked-from 86 and linked-to 88 fields may either contain copies of the corresponding entities (e.g. name), or they may be pointers referring to the actual records of the corresponding entities in the all-entities table/dataset 70. Other fields may be included in the links table/dataset 82, such as a link subtype, link subjects and objects, etc.

Any or all of the tables 70 and 82 may optionally include a document column/field, with which links or entity records may be associated with documents in the document table 90. Each record or document in the document table 90 may include a copy or link to a document, a date of the document, a description of the document, a source of the document, or other document-related fields.

The precise choice of tables in FIG. 4 is not a necessity. Other table arrangements are possible. For example, one table could store both entity records and link records. In a preferred embodiment, one metadata table is used to describe entity record types, another metadata table is used to describe attributes, and another metadata table is used to describe the types of links. As discussed later, although links are shown in FIG. 4 as having only a type, links may also be designed to have a general classification, and a type or category within the classification.

There are various advantages of using a generic storage format for entity records and metadata or any mechanism for mapping between the generic storage format and a datatyping of the records so stored. New datatypes can be added on the fly. A new attribute can be added to an entity type by simply adding a new metadata row keyed on the attribute's entity type and identifying an attribute column in the entity table 70 which contains the new attribute and also naming or describing the new attribute. A new column in the table/structure 70/72 is not needed; a column previously not used by records of the data type is put into use. Furthermore, the same software may be used with any variety of different subject matters (i.e. types of entities), the only difference between subjects will be the types of entities and links, as described by the various metadata. The metadata can also be used to define flexible user interface elements such as column headings, pull-down menus, and the like. As seen in detail later, the text for such elements can be derived directly from the metadata tables. If a new link category or type is added, a corresponding new metadata entry is added. When a user interface element listing the link types (including the new link type) is needed, the elements of the list can be dynamically determined according to the metadata. Thus the new link type or category will appear in the list without requiring any coding changes.

The search field 76 and its index 74 also offer various advantages. The search field 76 will generally, for any given entity type, be a combination of various salient attributes. The index 74 simply provides a single search space for searching all of the salient attributes for all of the entities in the all-entities table 70. It may be convenient to have a database trigger or the like that automatically updates or creates an entity's search field when its salient attributes are created or updated. The index 74 will preferably be a single index that may be any of a variety of types of indexes, which are generally well known in the art. The index 74 will preferably span the entire all-entities dataset 70, thus enabling a single search to search all entity records in the all-entities dataset 70, without regard for entity type.

As mentioned earlier, scoping the link and entity records on a document basis is beneficial when ongoing use of the original documents is desirable, however the documents and references thereto are not a necessary aspect.

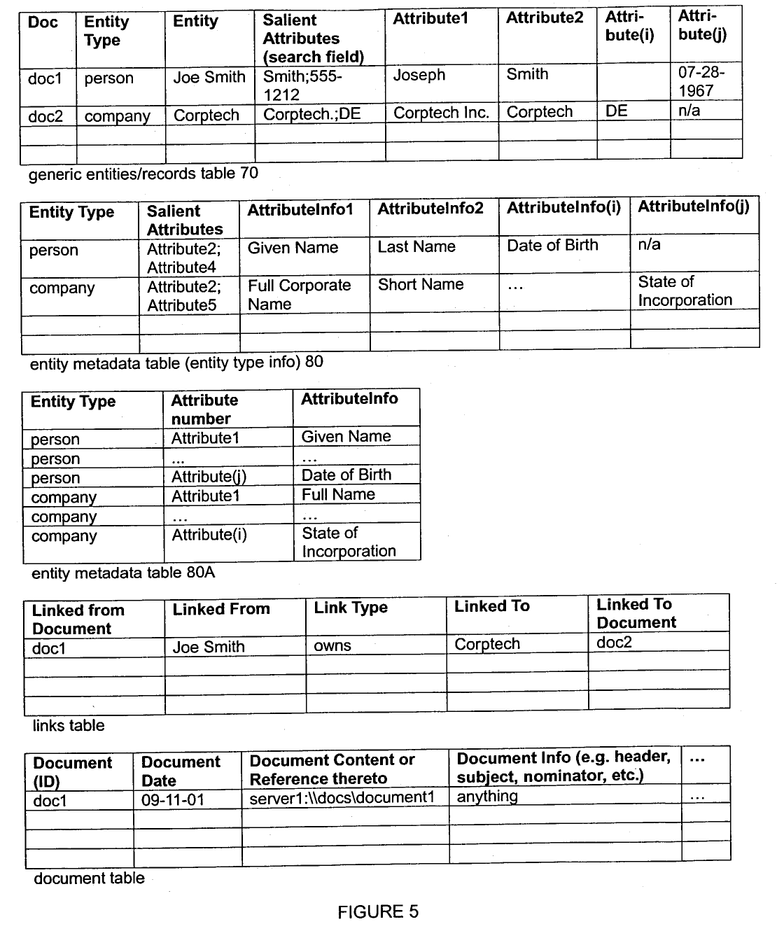

FIG. 5 shows examples of possible tables or datasets. An implementation of an entity table 70 might include person and company entity types according to either entity metadata table 80 or 80A. The person entity type is described—by one row in the entity metadata table 80—as having a search field with salient attributes 2 and 4, which are Last Name and Phone Number, respectively. That the person and company entity types are different general entity types is apparent because they have different numbers of attributes (j and i, respectively) with different attribute descriptions. The search fields need not be stored in or with the metadata, but rather can be hardcoded, stored in a separate table, etc. The metadata table 80 can also be implemented in the form of entity metadata table 80A, which describes the entity types using multiple rows for each entity type.

As mentioned above, multiple entities/records of different types are stored in an all-entities dataset 70. An entity can be defined as any discrete piece of information representing a tangible or intangible subject usually about the real world, possibly having attributes or features. Examples of common entities are individuals, companies, organizations, vehicles, financial instruments, bank accounts, cities/locations, or special events. This list of possible entities is for illustration only and is not exhaustive; many other types of entities exist. For convenience, “entity” and “record” are used interchangeably throughout this specification, although “record” also refers to a unit of data storage, for example a row in a table, a node in a linked list, an item in a dataset, etc. Each entity in the all-entities dataset 30 will be any of a plurality of possible entity or record types. Generally, records of specific entities will be stored with a common generic format in the all-entities dataset 70. An entity type can also be defined as having a unique set of attributes or attribute names/descriptions, as might be described by metadata.

A dataset may be defined as a major unit of data storage and retrieval, comprising a collection of data in a prescribed arrangement or format, possibly described by control information to which the system has access. For example, a table can be considered to be a dataset.

Data Entry

As discussed above with reference to FIG. 2, a Data Entry Analyst (DEA) will view a nominated document, determine the existence within the document of any entities, attributes, links, etc., and enter the same into the database or data repository 38 using a data entry interface or application.

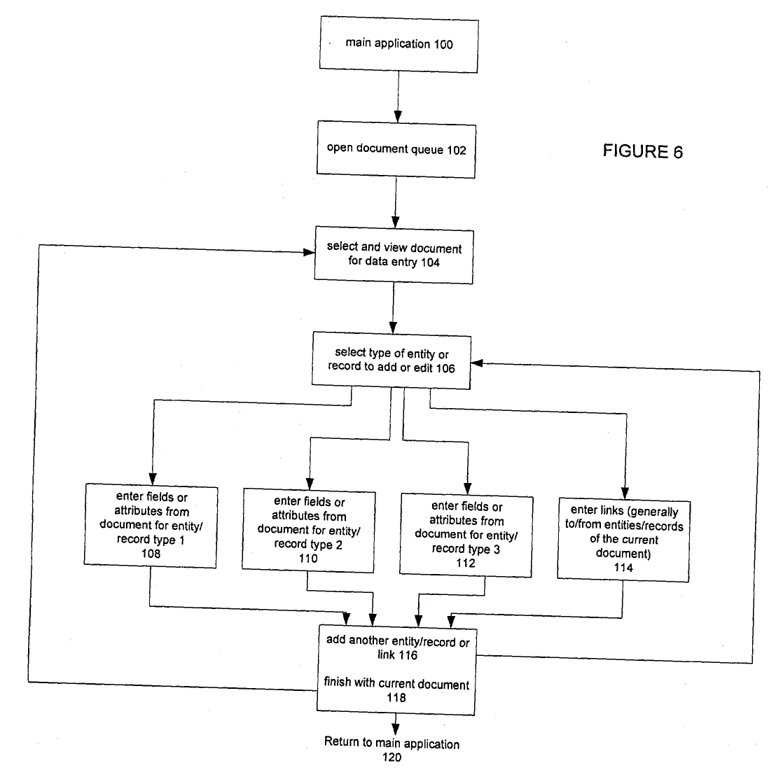

FIG. 6 shows one possible process for entering data from a document. From a main application a DEA opens 102 a view of the nominated document queue, and selects and views 104 a document for data entry. The DEA then repeats a process of selecting or determining 106 a type of entity or record to add or edit. Typically, a different form corresponding to each of the available entity types will be provided, with fields, selection menus, and the like corresponding to the attributes of the form's entity type. Such forms may be automatically laid out or configured at run-time or earlier using the metadata of the respective entity type. If there are three entity or record types 1, 2, and 3, then any of corresponding data entry steps 108, 110, or 112 respectively are chosen. If a link is to be entered (after at least two entities or records have been entered), then link entry 114 is chosen. The entity/record entry steps 108, 110, 112 or link entry 114 steps are repeated 116 until data entry of the document is finished 118. Other ways to enter entity and link information are possible.

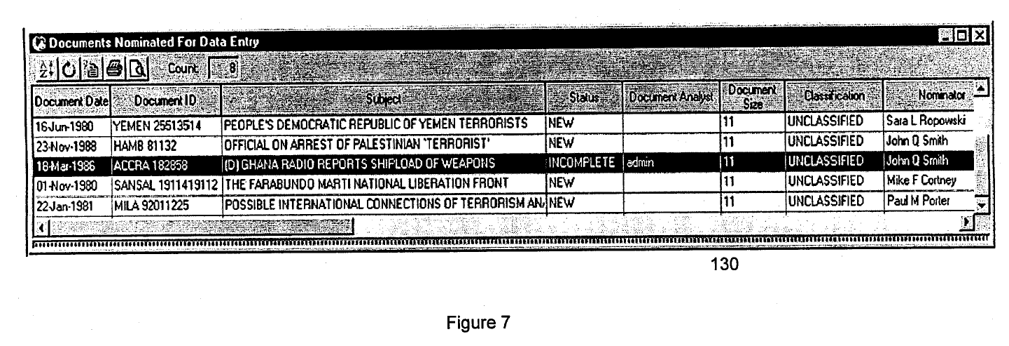

FIG. 7 shows a view 130 of a queue of documents nominated for data entry. View 130 can be used by a DAE, who can select a document for data entry by selecting one of the displayed rows. In this example electronic communications are the documents.

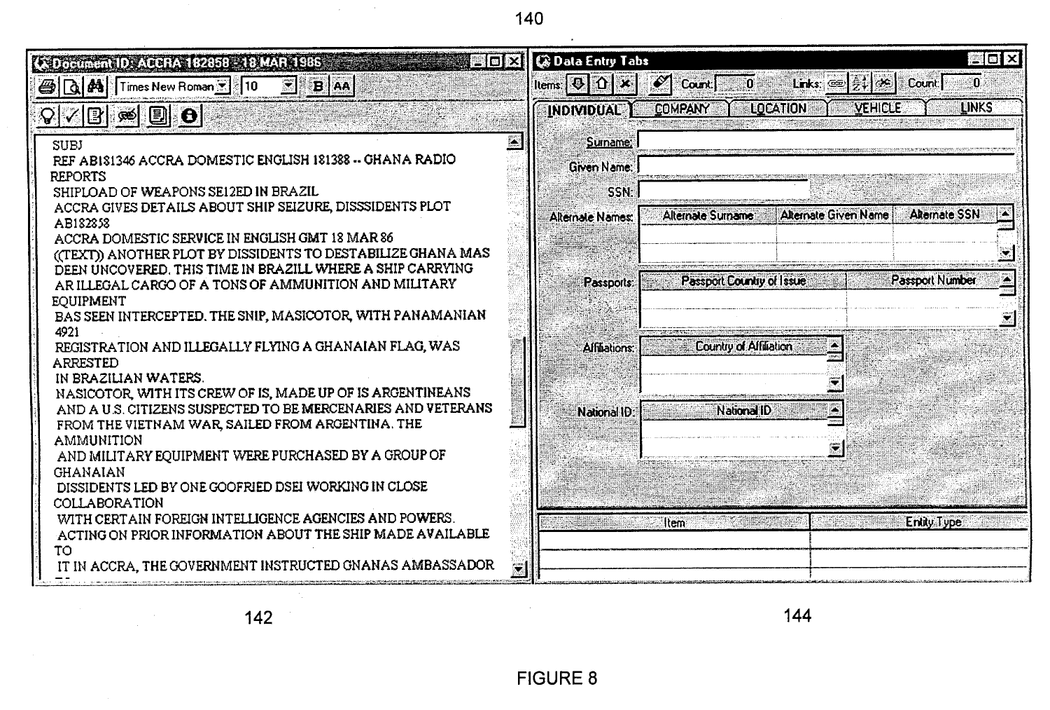

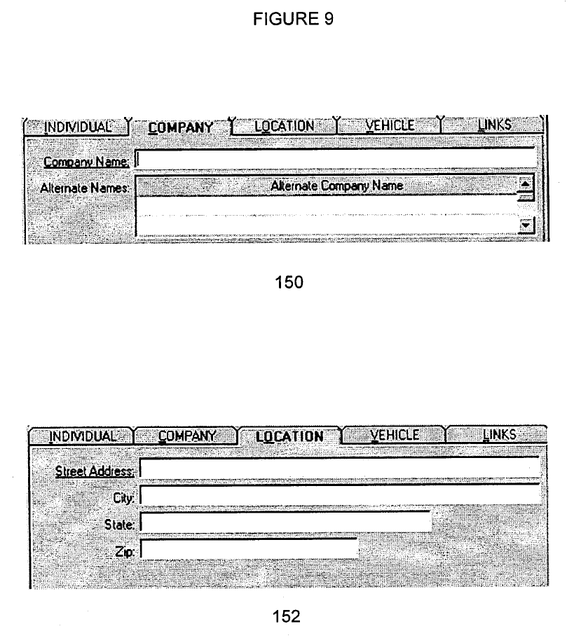

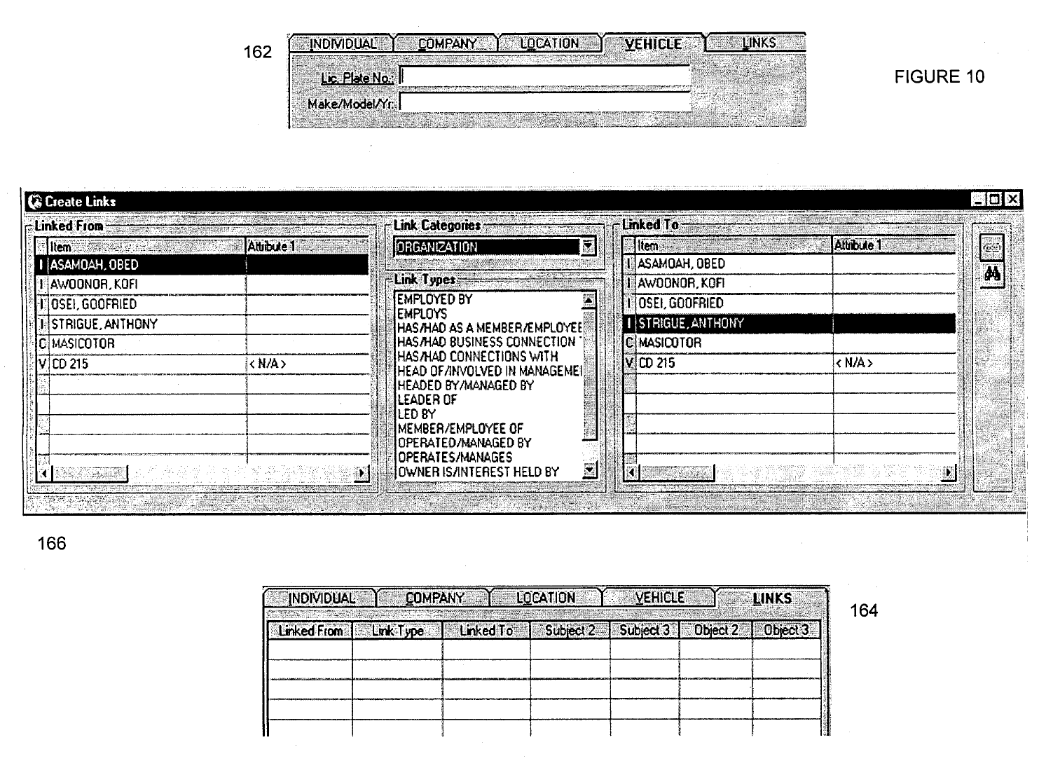

FIG. 8 shows a typical data entry screen 140. A document view 142 is shown simultaneously with a data entry screen 144. The data entry screen 144 has different tab views; individual, company, location, vehicle, and links. Each tab view corresponds to a different entity type that can be entered, and the data entry fields correspond to attributes of the entity type. FIG. 9 shows an exemplary company entity type tab view 150 and a location entity type tab view 152. FIG. 10 shows a vehicle entity type tab view 162 for entering vehicle entity type records and a link entry tab 164 for displaying links related to the current document and which displays links entered using the Create Links interface 166.

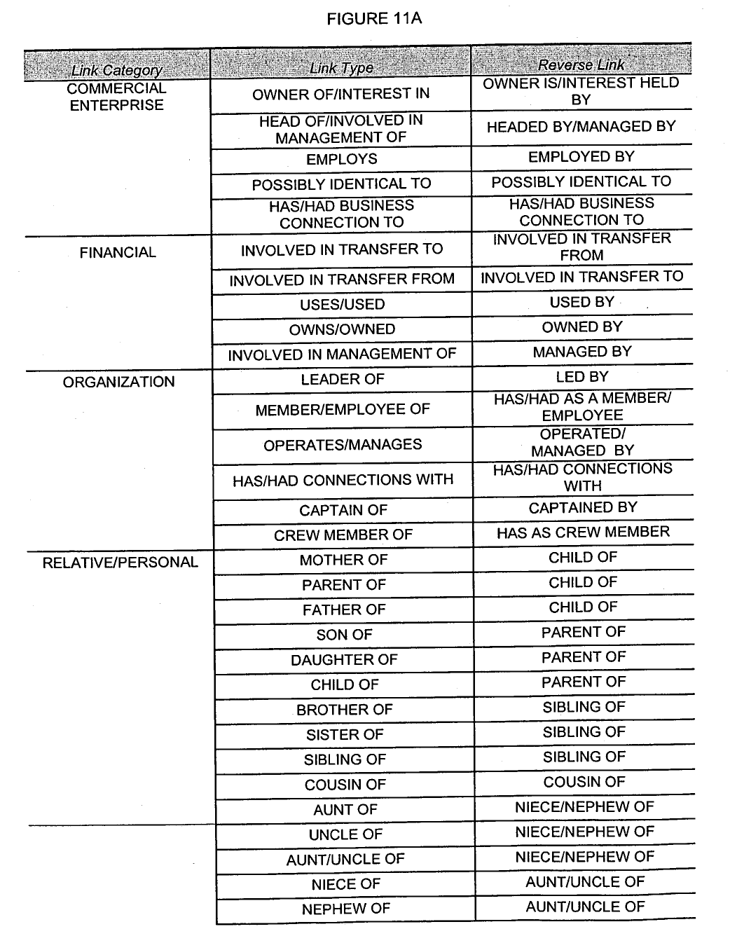

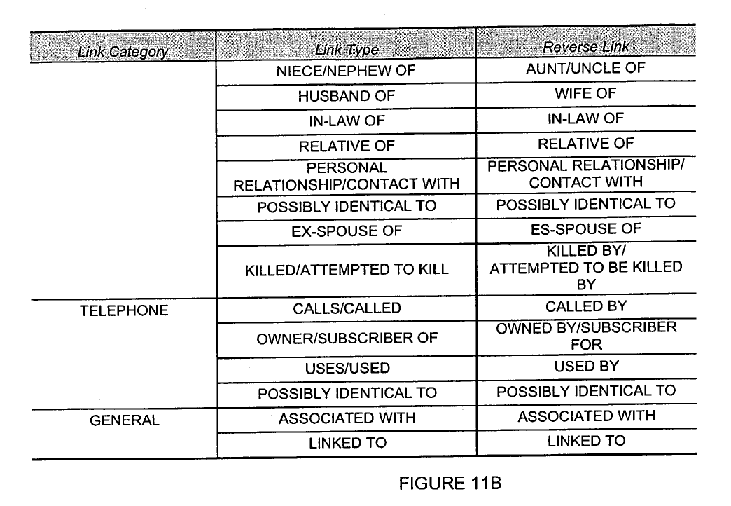

The Create Links interface 166 has a list of linked-from entities, link categories/types, and linked-to entities; any combination of the three may be used to enter a new link. For example, other entities from the all-entities dataset 72, without regard for document, could be linked by typing the name of the entity or by searching the all-entities dataset 72. The records available for selection to be linked can be obtained by any number of means, including entity searches, document selection (obtaining entities associated with a document), etc. The linking can also be done graphically, for example by drawing lines between textually or graphically displayed entities. FIGS. 11A and 11B show examples of possible entity categories and link types used to characterize the relationships between entities.

Search Capabilities

One purpose of the arrangement, discussed above, of different entity or record types with links between, is to allow a user to perform flexible and sophisticated searches on linked data. That is to say, various and disparate entities or discrete bits of information with links between them may be searched as a single dataset. More specifically, the search capabilities include: an “all-entities” search providing the ability to search all of the entity records of different types, some having links, with a single search, possibly using a single index; an iterative search capability where a result search from a previous search can be further searched including searching for links to the previous search results; and a “point-to-point” search to find a connection path, between any two entities/records of any type, the search path comprising any types of entities/records or types of links connecting them.

All-Entities Search

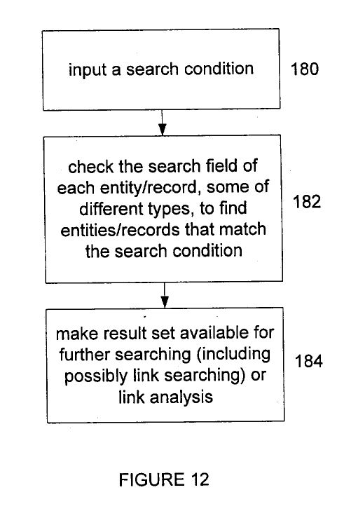

FIG. 12 shows a process for performing an all-entities search. A user enters 180 a search term or search condition (e.g. “smith”), and search logic (e.g. “contains”, “exact”, “sounds like”, etc.). The database or data repository 38 searches 182 the search field 76 of each entry (entity/record) in the all-entities table/dataset 70 for the search term or condition according to the search logic, using index 74 if so provided, and returns as a search result all of the found entity records. The search result set is made available 184 for further searching (search refinement), link analysis, link searching (discussed later), etc. Thus, in one quick process, an Analyst can go from a large difficult-to-work-with dataset (all-entities dataset 70) to a more manageable and relevant dataset (the search results), which can serve as a springboard for additional focused search or analysis. The relevant or reduced search result contains relevant entities or records, of potentially multiple types, that are part of a database having links. That is to say, the records in the search result may have pre-determined explicit links to or from them, thus allowing link search analysis. In sum, an Analyst may in one step proceed from a large dataset with many disparate entity records of different types to link analysis on records that are known to be relevant to a particular topic (e.g. “smith”). During this process, the data is presented in a readable tabular format, which allows for large volumes of data to be meaningfully presented.

As mentioned above, the all-entities dataset 70 of entity records is preferably provided with a search field 72 and an index 74 that indexes the search field 72. The search field 72 will generally comprise one or more field or attribute columns for each different entity type. The search field 72 may alternatively be a distinct attribute not overlapping or being made of other attributes. For example, a Person entity type might have a search field of first name, last name, and alias. A business entity type might have a search field of business name and owner name. All records of a given entity type will preferably be similarly composed of the same fields or attributes of that given entity type, and the attributes of the entity type's search field will generally be the salient features or attributes that have been deemed to be relevant to the given entity type. The search field can also be manually appended, changed, etc., or may be created ad-hoc for some or all records.

With the prior art, if a user desired to find all records in a database having a specified string/number, the user would need to perform many different manual searches, or would need to search many different tables and different fields, which was difficult and time consuming. It was difficult to perform link analysis on the different result sets of different record types as a whole. There were no explicit links across record types. The all-entities search allows link analysis on a dataset without regard for the underlying organization or typing of the data.

Search Refinement

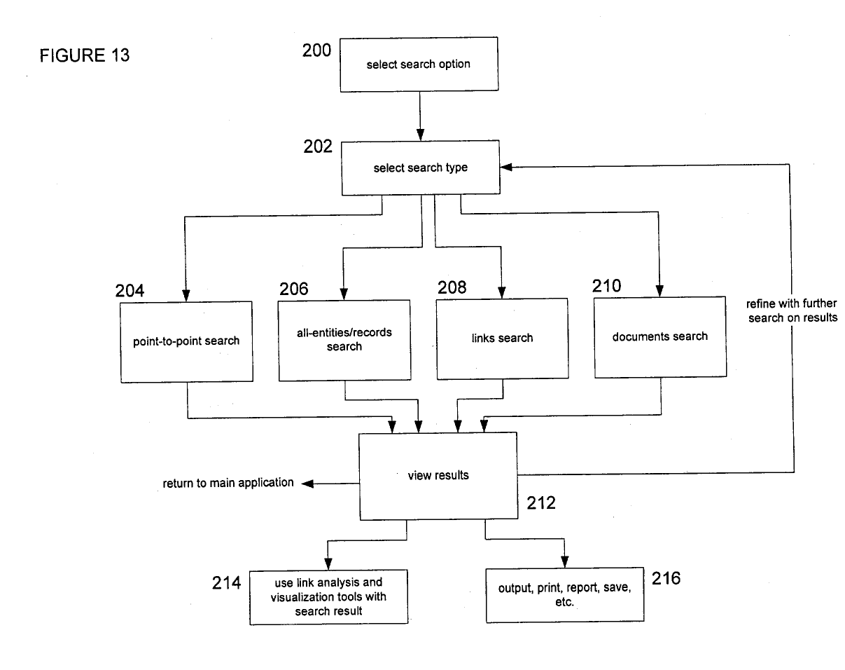

FIG. 13 shows a process flow for performing refined searches. An Analyst or user will initially, perhaps from a main application window, select 200 a search option. The user will then select 202 a search type from among any of the different search types. Accordingly, the user will provide input to perform one of a point-to-point search 204 (discussed below), an all-entities search 206, a links search 208, or a documents search 210 (if documents are included). The user may then view 212 the results and either refine the search result (again selecting 202 the search type), use 214 data visualization tools on the search result, or otherwise output 216 the search result (e.g. save, print, export, etc.).

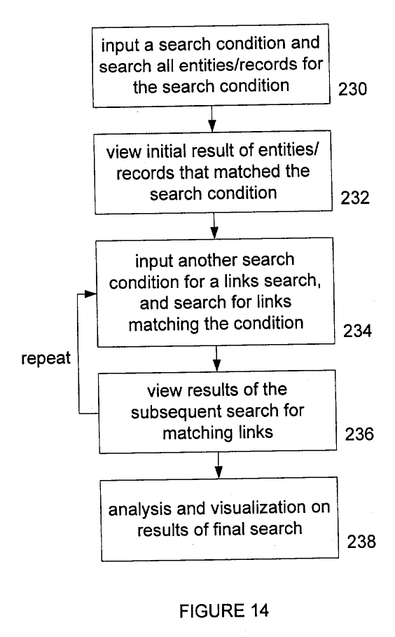

FIG. 14 shows a practical consequence of the search refinement capability discussed with reference to FIG. 13. A user may input 230 a search condition, and view 232 the initial results. Then, while viewing 232 the initial results, the user may decide to perform a further search on the initial result by selecting 202 another search type (e.g. a links search), or otherwise filtering the search results. The user could input 234 a search condition for the link search on the initial result and view 236 the results of the second refinement search on the initial result. The user may then further refine the search using an iterative process, or proceed with typical link analysis, visualization 238, etc. based on the refined search results.

Search Details

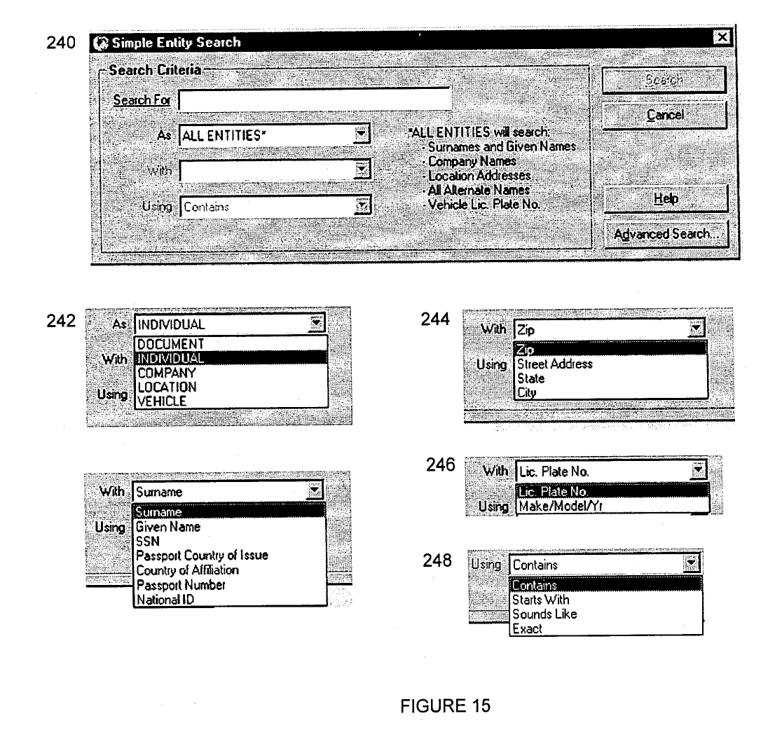

FIG. 15 shows a simple entity search screen that might implement an all-entities search 206. A main input area 240 can be used to enter a search term (“Search For”) for matching against the search field 76 of each entity record (or other entity fields/attributes if so desired). In the example shown in FIG. 15, there are several entity types, including, for example, an individual entity type (having search field attributes “Surname” and “Given Name”), a company entity type (having search field attributes “Company Names”), etc. An all-entities search for “smith” would return, for example, individuals with Surname or Given Name “Smith”, firms with “Smith” in their name, etc.

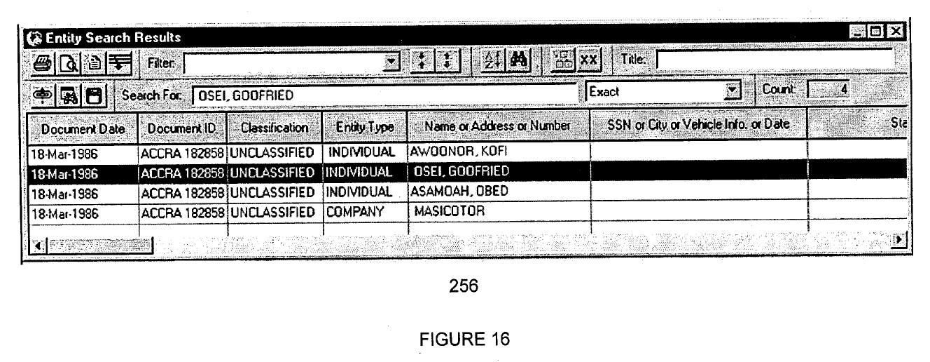

The all-entities search 206 can be limited to a particular entity type such as individual using the “As” selection 242 of input area 240 (interactively setting “As=Individual”) matching the “search for” field. As shown in list 244, the search may optionally be further qualified by an attribute of an entity type that matches the “Search For” search condition. Listing 244 shows all attributes of the location example entity type, which would be available for “With” restriction if the search is restricted to the location entity type. Similarly, listing 246 shows attributes of a vehicle entity type. The “Using” condition or restriction list 248 is a self-explanatory search logic setting. FIG. 16 shows an example of a search result 256 from an all-entities or restricted all-entities search.

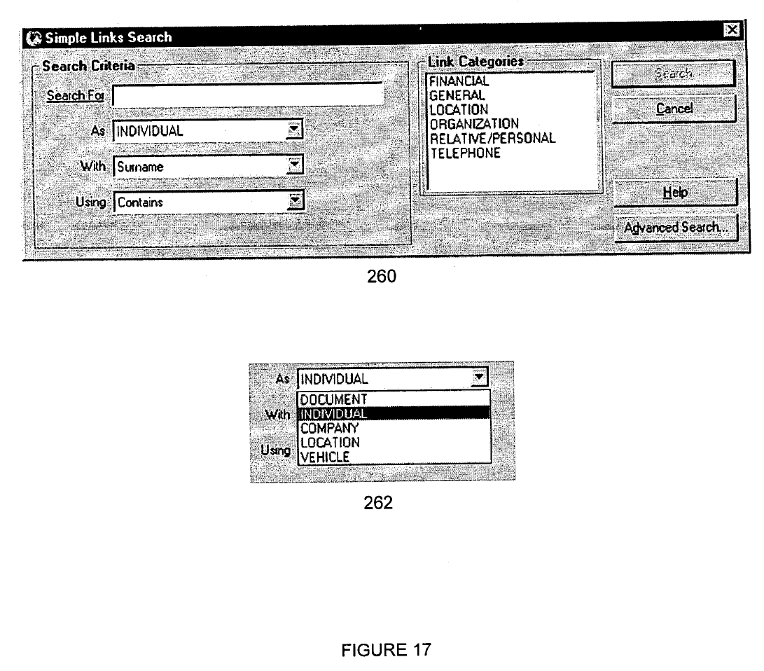

FIG. 17 shows an interface or input area 260 that could be used to implement the links search 208. By selecting a Link Category, links of a given category may be searched for. Generally, because links are also meaningful with reference to the entities to which they are connected, a links search 208 may be restricted to links to/from entity records that match a string (“Search For”), or an entity type (“As”), or an attribute (“With”), etc.

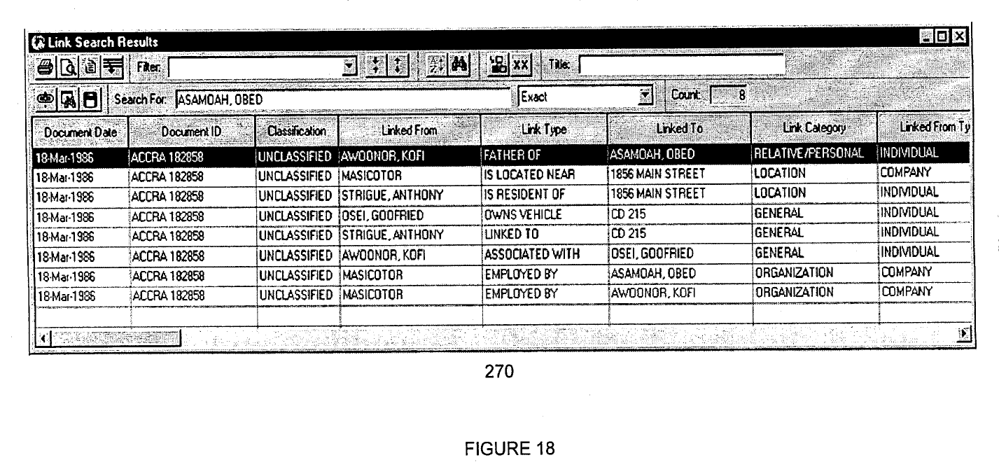

A links search 208, for efficiency, may preferably begin by searching the links table/dataset 82 for links of a given category or type (if so specified). Links that match or link to entities that match the search term or search string are searched for. FIG. 18 shows a typical links search result 270 from a links search 208. Any of the other search types can be performed on the links search result 270, or the links search result 270 can be used as input to a link visualization or diagramming tool.

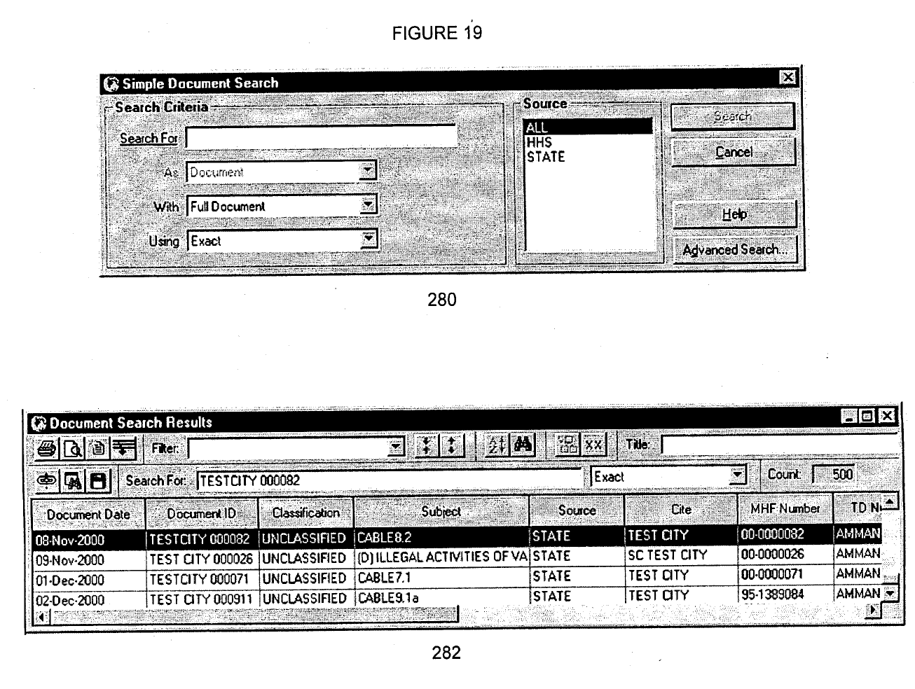

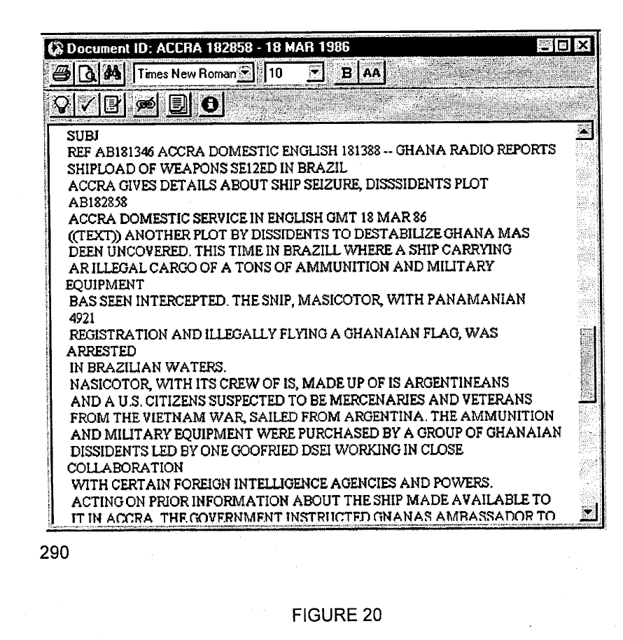

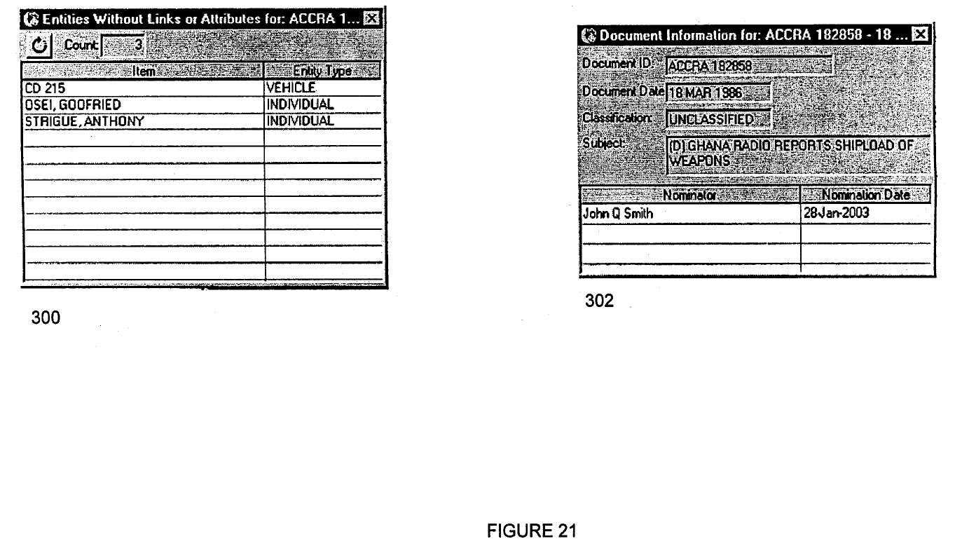

In an embodiment where document scoping is provided and documents related to the links and entity records are stored, a document search 210 capability may also be provided. FIG. 19 shows an exemplary document search interface 280. The “Search For” field may be used to enter a term to match to the documents, and various other document fields may also be used. A document search result 282 shows ordinary data of matching documents. However, an individual document may be selected for viewing. An individual document may be selected for finding link or entity information related to the individual document. FIG. 20 shows an example document view 290. FIG. 21 shows other document-related information such as entities in the document that lack links or attributes 300 and detailed document information 302.

With any of the searches discussed above, such as the all-entities search or the links search, a user can perform a single search on a comprehensive dataset of multi-type records that are linked to each other by links prior to the single search. The initial search results may include a quantity of records that is prohibitive of meaningful analysis. Therefore, the records are presented in a tabular fashion, where columns and rows of the table can be interacted with and manipulated. A set of records or columns may be interactively selected. Any number of operations can be performed, either on the entire results dataset or on the selected columns/rows thereof. Such operations include, but are not limited to: filtering out rows from the results that do (or do not) contain a selected value in a selected column, reordering based on one or more selected columns, searching for a value in the dataset, sending the selection to an analysis or visualization tool, merging entities, searching for links to the selected items, searching for entities matching selected criteria, etc. This type of refinement to matched records allows a user to render search results susceptible to manageable sets of data and meaningful link analysis.

At any stage of searching, whether initial or refined, or after any type of search (all-entities, point-to-point, etc.), the records in the current dataset will be available for instant link analysis because of the preexisting links between the records.

Point-To-Point Search

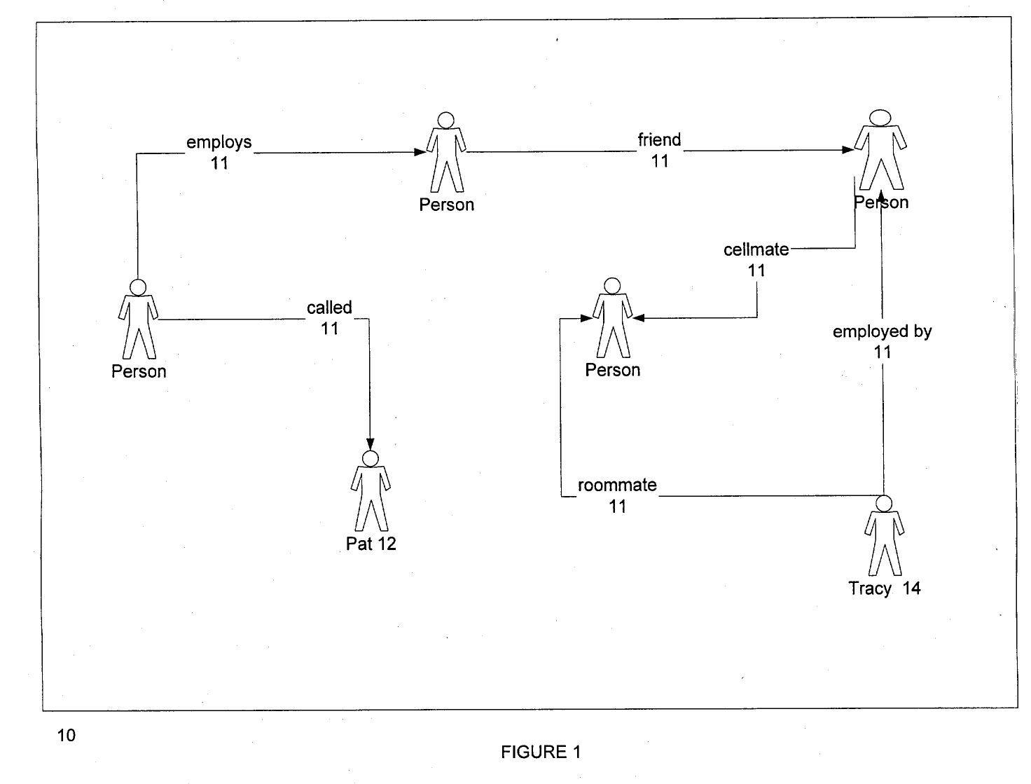

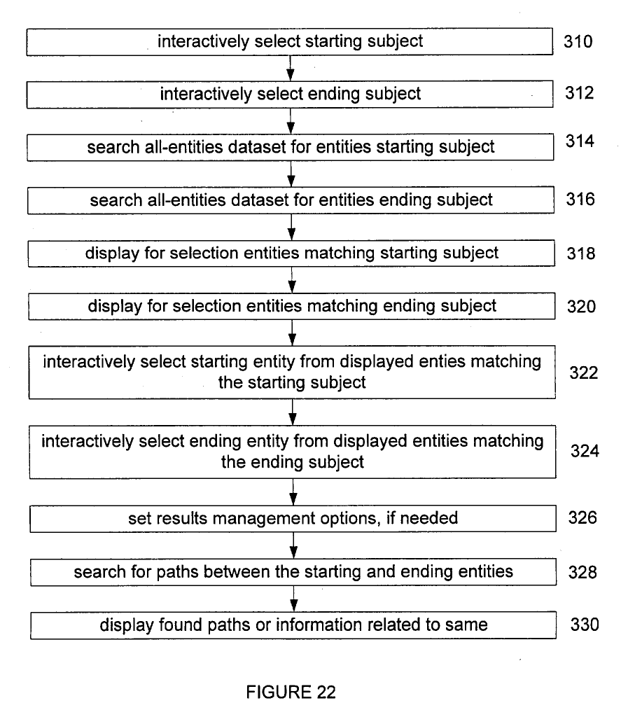

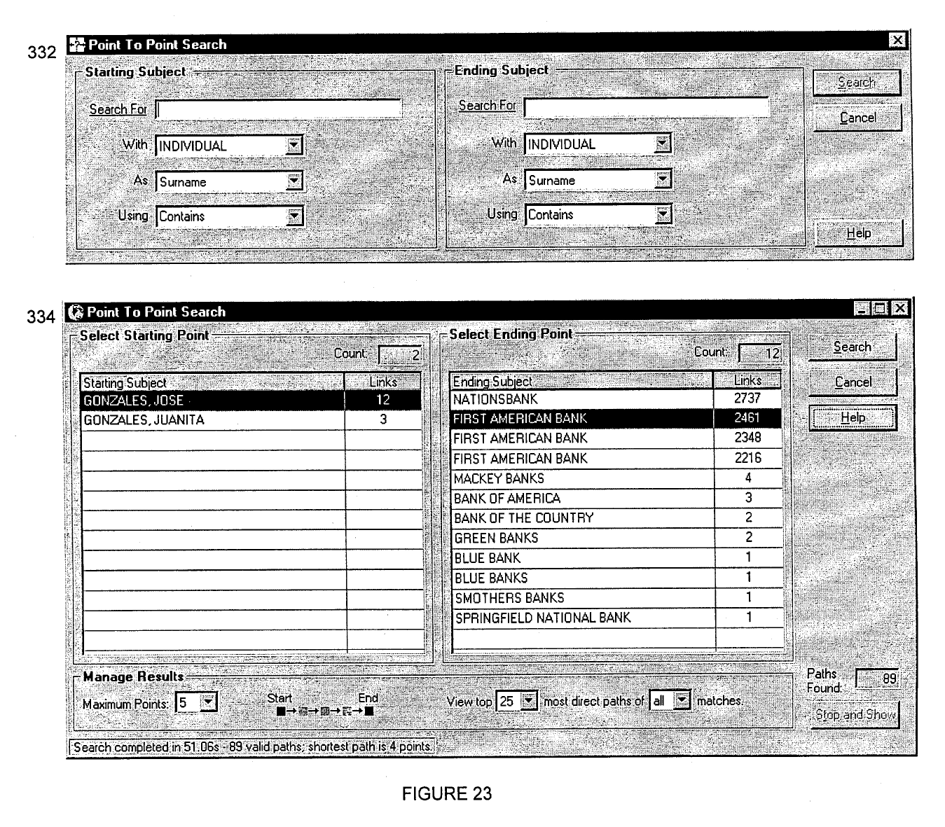

As mentioned above, the point-to-point search 204 is another type of search that may be performed on the link and entity records. FIG. 22 shows a general process flow for performing a point-to-point search 204. A point-to-point search is a link analysis technique to identify relationships between two entities (i.e., points) that do not necessarily have a direct link path between each other. For example, in FIG. 1 there is no direct relationship between Pat 12 and Tracy 14, however, Pat 12 called a Person who employs another person who is a friend of yet a third person who is employed by Tracy 14. This relationship is obvious when looking at FIG. 1, but when dealing with thousands or millions of entities and relationships the number of paths between two entities becomes nearly limitless if the scope of the point-to-point search is not limited to a reasonable number of points. For example, as illustrated in FIG. 23, a Maximum Points field (shown in interface 334) may help limit the scope of a point-to-point search. By specifying the maximum points of a point-to-point search, search paths that exceed the limit are avoided. Initially, a user will interactively select 310, 312 a starting subject and an ending subject. Such subjects may be, for example, entity search criteria similar to the entity searching functionality discussed above. The all-entities dataset or table 70 is searched 314, 316 for entities matching, respectively, the starting subject/criteria and the ending subject/criteria. The results are displayed 318, 320. The user then selects 322, 324 a starting entity and an ending entity from among the earlier found 314, 316 and displayed 318, 320 entities. Limiting conditions may be set 326. For example, a maximum length of paths between the starting and ending entity, a maximum number of paths to display, etc. Paths connecting the starting and ending entities are found 328 and information related to the found paths is displayed 330.

It is also possible to qualify the paths to be found, for example by requiring a path to contain at least one of a certain category or type, or paths formed only by links of a certain type. Types or qualities of entities in the path may also be specified.

FIG. 23 shows a typical interface 332 for selecting 310, 312 starting and ending subject/criteria, and a typical interface 334 for displaying 318, 320 and selecting 322, 324 starting and ending entities to find point-to-point paths between. The Links column in interface 334 shows the number of possible different paths for the corresponding Subject.

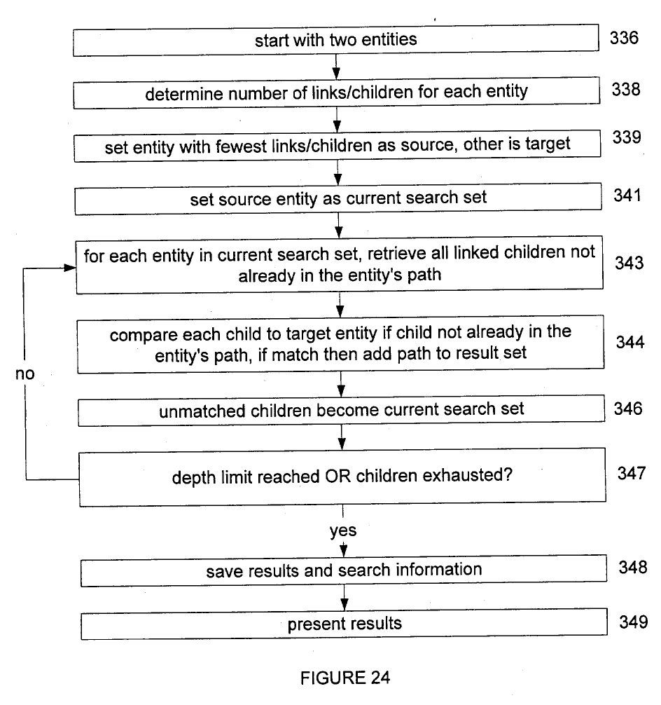

FIG. 24 shows an algorithm that may be used to search for paths between two points or entities. The algorithm is in general an original type of breadth-first search. Starting 336 with two entities, it is preferable to determine 338 the number of links or children directly linked to each of the two entity endpoints. By setting 339 as the source point the entity with the fewest direct links, the overall breadth of the search should be reduced. Other methods for selecting a preferable start point may be used. For example, different link types may be given different weights, etc. The other entity is deemed the target point entity. The search begins by setting 341 the source point entity as the initial current search set, and, as to be shown, the current search set is repeatedly expanded.

Each search iteration (343, 344, 346, 347) works on a current search set. For each entity in the search set, all children entities directly linked thereto (but not already in the entity's search path) are retrieved 343. Each child entity is then compared 344 to the target point entity, and if it matches, the record/link path behind the child entity (which goes back to the source point entity) is added to the result set. After processing all child entities, any unmatched children become 346 the next current search set. If 347 the depth of the search (current path length) has not been reached, and if the current search set is not empty, then the process 343, 344, 346, 347 is repeated. Otherwise, the search results are saved 348, preferably with information identifying the time and details of the search, and the resulting set of paths is presented 349, for example for display or link analysis.

In practice, the direction of a link is ignored when searching out a path. A unique identifier (key) to the link dataset is recorded, allowing all true paths and link relationships to be displayed. In a preferred embodiment, a database and stored procedures are used to implement the point-to-point search. A main or driver stored procedure is the public interface to the point-to-point search. The driver receives the search parameters from the user and executes the search accordingly.

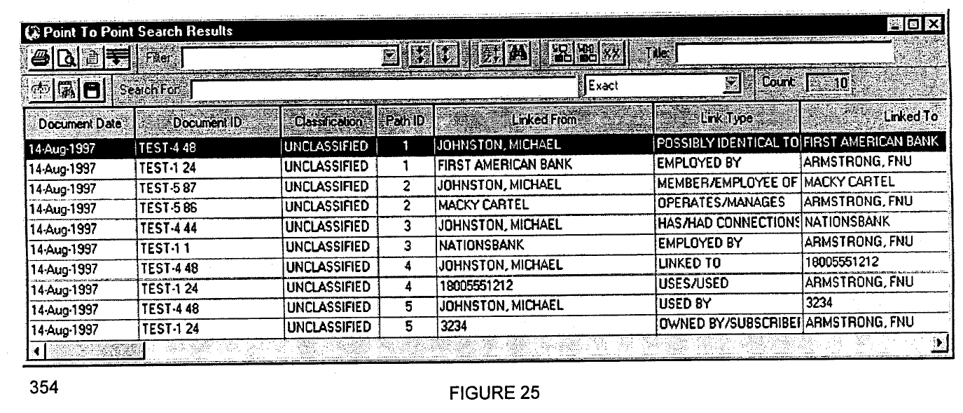

FIG. 25 shows a typical interface 354 for displaying 330 found path information. A feature specific to the point-to-point search results interface 354 is the Path ID column. The Path ID identifies each point-to-point search path. Rows with a same Path ID are elements of a same path. Any number of visualizations or displays may be used, such as displaying visual path maps, etc.

A notable feature of the point-to-point search is that paths between two entities of any entity type may be found, and the paths may comprise chains of any type of entities linked by any type of link. Also, all of the paths can be found in one step, rather than through an iterative process. Search results may be presented in tabular format and may be interactively manipulated, searched, or refined by iterative or further searching, as discussed above with respect to searching in general.

Miscellaneous Features

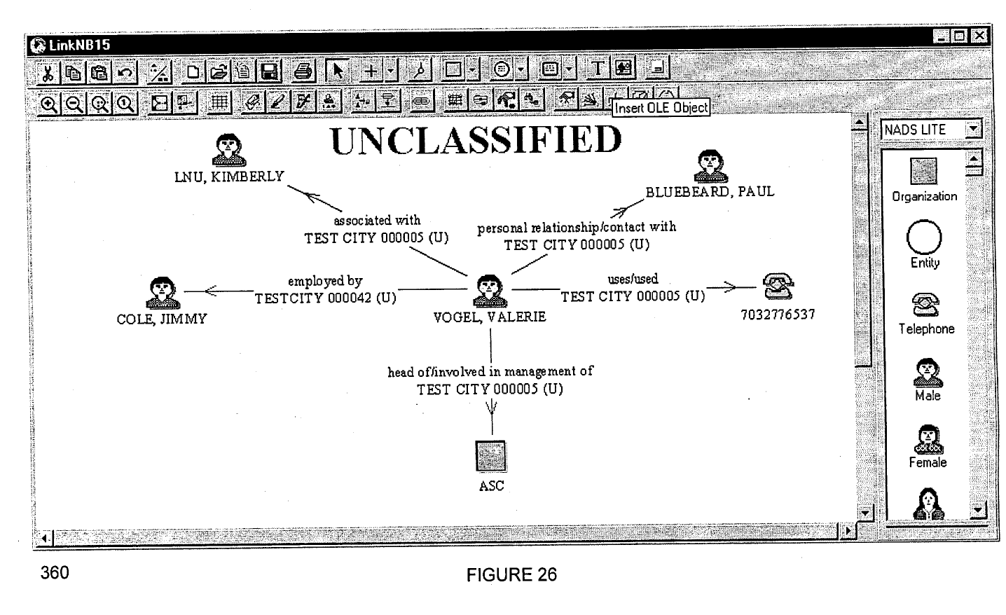

FIG. 26 shows a typical visualization 360 that might be obtained using a commercially available visualization tool. Entity and link information may be passed to such a tool using Object Linking and Embedding (OLE), clipboard cut-and-pasting, import/export functions, Interprocess Communication, etc.

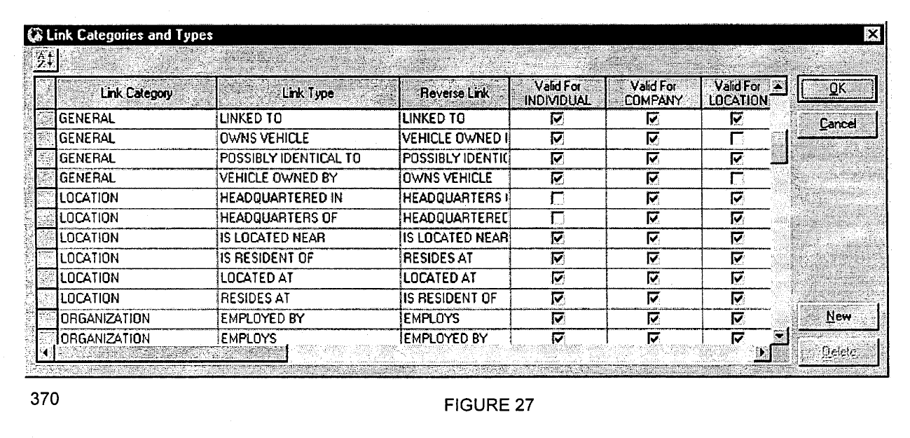

Any number of data rules may be imposed on the tables in the database or data repository 38. In particular, because the different entity types and link types are freely intermingled and linked, it is preferable to allow logical restrictions to be placed on what types of links may be made between certain entity types. FIG. 27 shows an interface 370 for imposing link rules.

Preferably, relevant reverse links are automatically entered in the links table/dataset 82 when a link is first created. The interface 370 may be used to set rules for reverse links.

It is also preferable to present result sets in matrix format, as shown for example in FIGS. 15 and 17. Operations such as search refinements may then be interactively controlled by interactively selecting rows and columns in the matrix. For example, an Analyst may highlight a row on result set, and search for predetermined values in the row. Rows can also be directly filtered, generally or by selected columns.

As mentioned above, the use of generic data formats and metadata describing types of records in such generic format allow for dynamic modification or addition of data types. The metadata can be used to dynamically construct user interfaces, for example upon instantiation, thereby reflecting the current available range of data types, attributes, link types, etc.

Additionally, some of the record or entity types may be provided with a variable number of attribute values for any given attribute. This is preferably done by allowing multiple records in the all-entities table/dataset 70 for any one entity, where the different records will have different attribute values for the same attribute/field.

Audit trails can be readily included and may be helpful in intelligence, counterintelligence, or counter-terrorism applications.

Conclusion

The present invention has been described with respect to a system for link analysis, having plural records of plural different record types stored in a data storage unit, and having plural links of plural link types stored in the data storage unit and linking pairs of the records, where at least some of the pairs are records of different record types. The system may also have an index indexing the plural records of plural different record types. The plural record types may have names of fields and the plural record types vary in a number of field names or names of fields. The plural records may also have fields corresponding to the field names of their respective record types, where the records are stored with a same record storage format, and where the different record types vary in a number of fields or names of fields. The index may index one or more of the fields of each of the plural records of plural different record types. The records may correspond to real world entities or information, and the fields and their names may correspond to attributes of the entities. Metadata or the like may be used to map the fields to the field names, and may be used to sensibly display related information, such set of the records, etc.

All of the entity records may be quickly searched at one time. Point-to-point searches for paths between entities may be performed without regard for link or entity types in such paths. Search results may be iteratively refined.

It may be appreciated that the inventive concepts discussed may be used to create tools useful in law enforcement and counter-terrorism investigation. A key task of counter-terrorism experts is to identify relationships between entities, in particular suspect individuals that may be a part of or supporting a terrorist cell or network. Sometimes, a single phone call between two people or from one company to another can be the critical link between two people suspected of having a direct or indirect relationship. Aspects of the present invention allow a law enforcement or counter-terrorism expert to compile or search disparate types of information and synthesize that information into a coherent set of searchable information, including unrestricted link searching and analysis. Large sets of data become usable, and link analysis can be more quickly targeted to a particular subject.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact construction and operation illustrated and described, and accordingly all suitable modifications and equivalents may be resorted to, falling within the scope of the invention.

What is claimed is:

1. A system for link analysis, comprising:
a record table with a generic format having plural records of plural different record types, where the records represent real world entities or events of different types;
a link table with links of plural link types, the links linking pairs of the records, where at least some of the pairs comprise records of different record types, and where the links represent real world relationships, according to the link types, between the real world entities or events represented by the records;
mapping information mapping the record types to information describing or identifying the real word entities or events represented by the record types, including information mapping generic columns or fields in the record table to specific attributes or descriptions of attributes of the different plural record types, the attributes or descriptions of attributes corresponding to attributes of the respective real world entities; and where
a first search term may be compared, for searching, to all of the records in the record table or all of the links in the link table or both, and where a result of such searching may be further searched in a similar fashion using a different search term or criteria.

2. A system according to claim 1, wherein the searching comprises also using a second search term, finding a first set of records of two or more types matching the first search term, finding a second set of records of two or more types matching the second search term, and automatically finding one or more direct or indirect paths between a record in the first set and a record in the second set.

3. A system according to claim 1, wherein the first search term comprises an entity, and where the searching is for indirect paths comprising links and records between and connecting the entity and another designated entity.

4. A system according to claim 3, wherein the searching further comprises determining or predicting which of the two searched entities will minimize computation for the searching if used as a starting point for the searching.

5. A system according to claim 4, wherein the determining is based on a number of entities directly linked to each of the two searched entities.

6. A system for link analysis, comprising:
a dataset of plural records of plural different record types stored in a data storage unit; and
a dataset of plural links of plural link types stored in the data storage unit and linking pairs of the records, where at least some of the pairs comprise records of different record types.

7. A system according to claim 6, further comprising an index indexing the dataset of plural records of plural different record types.

8. A system according to claim 7, wherein the plural record types comprise names of fields and the plural record types vary in a number of field names or names of fields; wherein
the plural records comprise fields corresponding to the field names of their respective record types, where the records are stored with a same record storage format, and where the different record types vary in a number of fields or names of fields; and wherein
the index indexes one or more of the fields of each of the plural records of plural different record types.

9. A system according to claim 6, where the records correspond to real world entities or events, and where the fields and their names correspond to attributes of the entities or events.

10. A system according to claim 8, wherein metadata mapping the fields to the field names is used to present a search result set of the records.

11. A system according to claim 6, wherein the plural records of plural record types may be interactively searched at one time with at least one search term, and where links of matched records may subsequently be interactively searched or analyzed.

12. A system according to claim 6, wherein a result of interactively searching the plural records of plural record types or the plural links of plural link types may be searched at one time with at least one search term, and where links of matched records may subsequently be further interactively searched.

13. A method, comprising:
capturing with a user interface one or more search parameters entered by a user;
performing a single search, using a single index of a dataset of records, for indexed records matching the one or more search parameters, where the records are of multiple different record types; and
presenting the matching records to the user for link analysis on the matching records, where the link analysis is performed using preestablished links linking one or more pairs of the records.

14. A method according to claim 13, wherein the records represent information about real world entities or events of different types corresponding to the different multiple record types.

15. A computer readable storage storing information to enable a system to perform a method according to claim 13.

16. A method of searching a system storing plural records of plural different record types stored in a data storage unit and storing plural links of plural link types linking pairs of the records, the method comprising:
allowing a search comprising at least one of:
interactively identifying two of the records of possibly different record types and automatically finding one or more paths between the two records, where the one or more paths may comprise any of the plural links of plural link types and any of the plural records of plural different record types; and
searching all of the plural records of plural record types with one search operation and one interactively inputted search term, and using a result of the searching all of the plural records to interactively perform further searching or link analysis based on the result.

17. A computer readable storage storing information to enable a system to perform a method according to claim 16.

18. A method, comprising:
capturing with a user interface one or more search parameters entered by a user;
performing a single search, on a comprehensive dataset of records, for records matching the one or more search parameters, where the records are of multiple different record types, and where the records are linked to each other by links of multiple link types stored prior to the single search;
presenting the matching records to the user in a tabular view;
rendering the matched records susceptible to meaningful manual analysis by interacting with the tabular view; and
using the links to perform link analysis on the refined matched records.

19. A method according to claim 18, wherein the refining comprises at least one of filtering, further searching, and sorting.

20. A method according to claim 18, wherein the link analysis comprises visualization of the refined matched records.

21. A method according to claim 18, wherein the link analysis comprises searching for paths between records in the refined matched records, where a path comprises one or more records linked by links.

22. A computer readable storage storing information to enable a system to perform a method according to claim 18.

23. A method for link analysis, comprising:
maintaining a unified dataset of plural records of plural different record types; and
maintaining a dataset of plural links of plural link types and linking pairs of the records, where at least some of the pairs comprise records of different record types.

24. A method according to claim 23, further comprising searching the records and links for paths of records and links that link two of the entities.

25. A method according to claim 24, wherein the searching comprises determining or predicting which of two entities will minimize computation for the searching if used as a starting point for the searching.

26. A system according to claim 25, wherein the determining is based on a number of entities directly linked to each of the two searched entities.
